(19) United States
(12) Patent Application Publication
(10) Pub. No.: US 2015/0199020 A1
(43) Pub. Date: Jul. 16, 2015

(54) GESTURE UI DEVICE, GESTURE UI METHOD, AND COMPUTER-READABLE RECORDING MEDIUM

(71) Applicant: FUJITSU LIMITED, Kawasaki-shi (JP)

(72) Inventors: Koki Hatada, Kawasaki (JP); Katsuhiko Akiyama, Kawasaki (JP)

(73) Assignee: FUJITSU LIMITED, Kawasaki-shi (JP)

(21) Appl. No.: 14/515,778

(22) Filed: Oct. 16, 2014

(30) Foreign Application Priority Data
Jan. 15, 2014 (JP) 2014-005218

(51) Int. Cl. G06F 3/01

(52) U.S. Cl. CPC G06F 3/017

(57) ABSTRACT

A gesture UI device includes: a CPU; a memory configured to store a program which is executed by the CPU; and a display device on which operation of screen is performed in accordance with a gesture input, wherein the program causes the CPU to: predict a direction of movement of a cursor on the screen on which a first object to be operated is displayed; calculate a non-movement region to which the cursor is expected not to move based on the direction of movement of the cursor; and place a second object to be operated on an inside of the non-movement region.

### CROSS-REFERENCE TO RELATED APPLICATION

This application is based upon and claims the benefit of priority of the prior Japanese Patent Application No. 2014-005218, filed on Jan. 15, 2014, the entire contents of which are incorporated herein by reference.

### FIELD

The embodiments discussed herein are related to gesture UI devices, gesture UI methods, and a computer-readable recording media on which a program is recorded.

### BACKGROUND

A technique related to a spatial gesture which is a user's gesture is applied to a user interface that is operated in a more intuitive manner than a mouse and a keyboard and is used when operation is performed in a position away from a screen. The movement made by the user to move the user's hand or another part of the user's body to a particular position or with a particular movement trajectory is referred to as a “spatial gesture”.

Related art is discussed in Japanese Laid-open Patent Publication No. 10-91320 or Japanese Laid-open Patent Publication No. 11-3177.

### SUMMARY

According to an aspect of the embodiments, a gesture UI device includes: a CPU; a memory configured to store a program which is executed by the CPU; and a display device on which operation of screen is performed in accordance with a gesture input, wherein the program causes the CPU to: predict a direction of movement of a cursor on the screen on which a first object to be operated is displayed; calculate a non-movement region to which the cursor is expected not to move based on the direction of movement of the cursor; and place a second object to be operated on an inside of the non-movement region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B each depict an example of a drag instruction method;

FIG. 2 depicts an example of erroneous operation related to a mode change;

FIG. 3 depicts an example of a gesture UI device;

FIG. 4 depicts an example of a functional configuration of a gesture UI device;

FIGS. 5A and 5B each depict an example of calculation of a non-operation region;

FIGS. 6A and 6B each depict an example of calculation of a non-traveling region;

FIG. 7 depicts an example of calculation of a non-traveling region;

FIG. 8 depicts an example of calculation of a non-movement region;

FIG. 9A depicts an example of trajectory calculation;

FIG. 9B depicts an example of boundary calculation;

FIG. 10 depicts an example of display of a movement trajectory;

FIG. 11 depicts an example of a processing of issuing drag instruction;

FIG. 12 depicts an example of a processing of issuing drag instruction;

FIG. 13 depicts an example of a processing of deletion instruction;

FIG. 14 depicts an example of display of a movement trajectory;

FIG. 15 depicts an example of calculation of a non-movement region;

FIG. 16 depicts an example of calculation of a non-movement region;

FIGS. 17A and 17B each depict an example of calculation of a non-movement region;

FIG. 18 depicts an example of display of a trajectory calculation result;

FIG. 19 depicts an example of trajectory calculation; and

FIG. 20 depicts an example of a hardware configuration of a gesture UI device.

### DESCRIPTION OF EMBODIMENT

An instruction associated with an object to be operated (for example, a screen element such as a button, a menu, or an icon) on a screen is executed by a particular movement trajectory of a cursor. For example, as a result of a certain gesture being input with a mouse, a state in which the button of the mouse is pressed or released is generated. An icon is selected without depression of the button of the mouse, and an instruction associated with the icon is executed. For example, the cursor is controlled by the movement of a finger, and a region surrounded with an edge is set around an object. When the cursor enters the region from below and goes out from the region to below, the object is dragged in response to the subsequent movement of the cursor.

When a mode change between a mode indicating operable and a mode indicating non-operable is not performed in a spatial gesture by reason that it is impossible to add a sensor and a recognition device, which are desired minimally for identifying a spatial gesture, another sensor and another recognition device, the movement of the user, for example, is erroneously recognized as a gesture by a system and unintended operation may be performed (false positive).

For example, the movement of the body of the user which is performed without the intention of performing screen operation, such as using items lying around the user, drinking or eating something, or touching the user's own body may be recognized as a gesture. For example, the gesture undesirably becomes part of another gesture, whereby an unintended gesture may be recognized.

In the present specification and the drawings, component elements having substantially the same or similar function or configuration are identified with the same reference characters, and their descriptions may be omitted or reduced.

In a spatial gesture, a mode change may not be performed easily. The “mode” includes a state of a system indicating a state during operation and a state during non-operation. For example, even when the same cursor operation is performed, screen operation is performed during operation and the screen operation is not performed during non-operation.

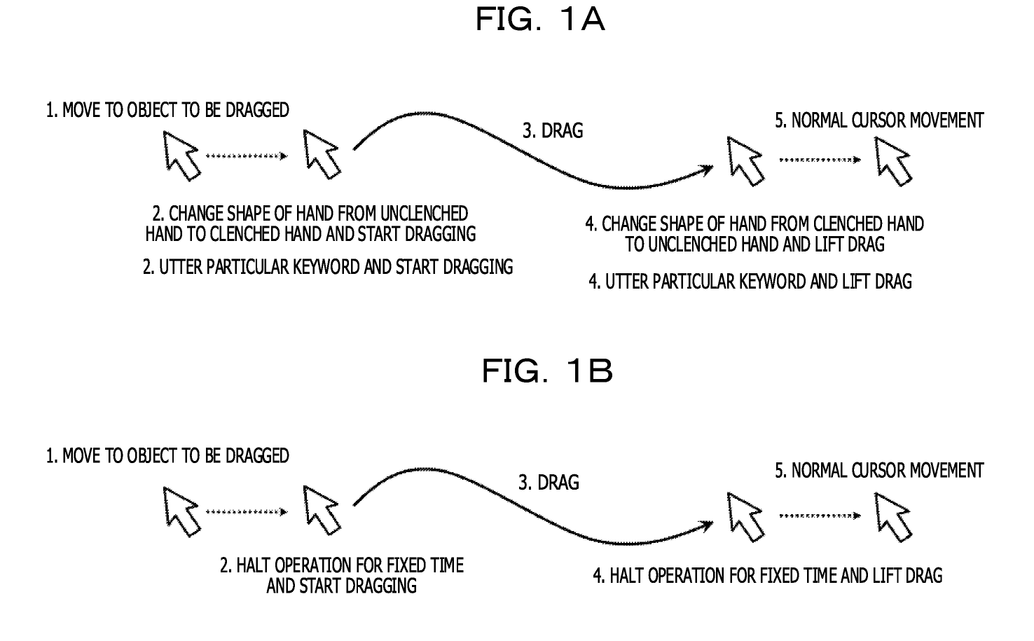

FIGS. 1A and 1B each depict an example of a drag instruction method. FIG. 1A depicts a drag performed by the shape of a hand or voice. FIG. 1B depicts a drag by a halt. As an example of a mode change in a spatial gesture, the shape of a hand is used. For example, by setting a state in which the shape of a hand is a clenched hand as a state during operation and setting a state in which the shape of a hand is an unclenched hand as a state during non-operation, a mode change is performed. For example, as depicted in FIG. 1A, after movement to an object to be dragged is performed (1), the user changes the shape of a hand from an unclenched hand to a clenched hand and starts dragging (2). After the object is dragged to a desired drag target position (3), the shape of a hand is changed from the clenched hand to the unclenched hand and the drag is lifted (4). The mode after lifting of the drag is normal cursor movement (5). If the above mode change is performed by using voice, the mode changes are performed as follows. After movement to an object to be dragged is performed (1), the user utters a keyword (for example, “drag”) and starts dragging (2). After completion of dragging (3), the user utters a particular keyword (for example, “end”) and lifts the drag (4). The mode after lifting of the drag is normal cursor movement (5).

Another example of a mode change includes a mode change by a halt. As depicted in FIG. 1B, after movement to an object to be dragged is performed (1), the user halts operation for a fixed time and then starts dragging (2). After the drag is performed (3), the user halts operation for a fixed time and lifts the drag (4). The mode after lifting of the drag is normal cursor movement (5). It may be determined that the user halts operation if the operation is stopped for a few seconds, for example.

As another example of a mode change, a body part other than a hand with which a gesture is made is used. For example, when a gesture is made with a right hand, the mode is changed by the position of a left hand. For example, a line of sight may be used. For example, if a line of sight lies near an object to be operated on the screen, the state may be set as a state during operation; if a line of sight lies in other positions, the state may be set as a state during non-operation. For example, when the distance between a hand of the user and the screen to be operated is used, if the distance is smaller than or equal to a threshold value, the state may be set as a state during operation; if the distance is greater than threshold value, the state may be set as a state during non-operation.

When the shape of a hand or voice is used in a mode change, in addition to minimum sensor and recognition device which are desired for a spatial gesture, other sensor and recognition device may be used. When a halt is used in a mode change, an instruction may be executed unintentionally. For example, when a halt is used, even when the hand is halted unintentionally, a drag instruction may be executed.

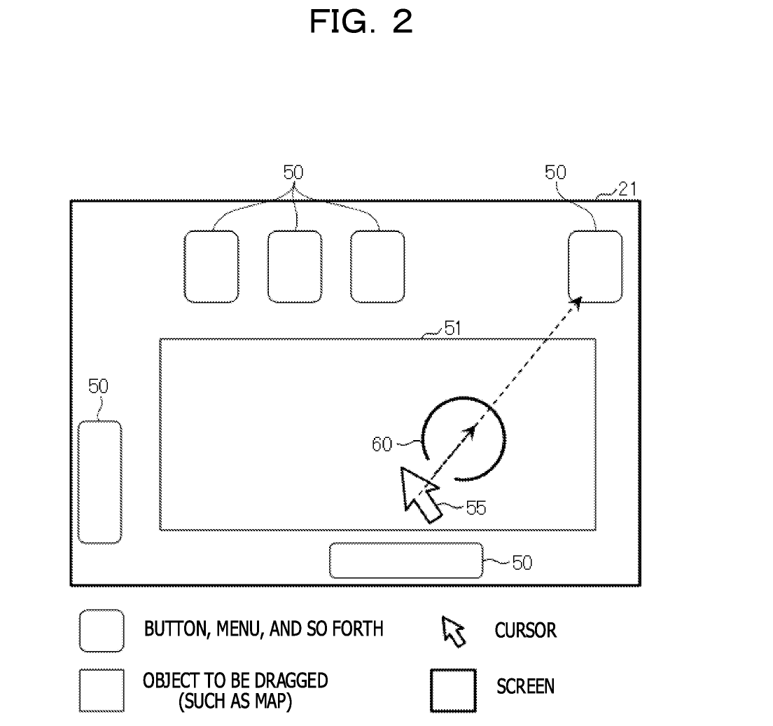

FIG. 2 depicts an example of erroneous operation related to a mode change. In FIG. 2, a mode change is performed without a halt, the shape of a hand, and voice. On a screen 21, in addition to buttons and menus (hereinafter collectively referred to also as a “button and menu 50”) and an object 51 to be dragged (a map or the like), a ring 60 with an opening in part thereof is displayed. As a result of a cursor 55 entering the inside of the ring 60 through the opening of the ring 60, a mode change is performed, and operation of some kind associated with the ring 60 is performed.

At this time, depending on in what position the ring 60 is displayed with respect to the position of the cursor 55 and with what movement trajectory the cursor 55 is operated, the ease of erroneous operation may differ. For example, as a result of the cursor 55 entering the inside of the ring 60 through the opening of the ring 60, a drag instruction may be executed. For example, the ring 60 is displayed in the position depicted in FIG. 2. When the user moves the cursor 55 toward an upper right part of the screen 21 with an intention of operating the menu 50 located in an upper right part of the screen 21, as indicated by a movement trajectory of FIG. 2, the cursor 55 unintentionally enters the inside of the ring 60 through the opening of the ring 60. As a result, incorrect operation in which an unintended drag instruction is executed occurs.

For example, in a gesture UI device, a region in which it is difficult for the user to move the cursor 55 unintentionally is calculated. A gesture which is made in the calculated region is set as a gesture for executing an instruction associated with an object to be operated (for example, the ring 60 or the like).

Of the objects to be operated which are displayed on the screen, the button and menu 50 is an object to be operated which is displayed on the screen 21, and may be an example of a first object to be operated. The ring 60 may be an example of a second object to be operated other than the first object to be operated and may be displayed, for example, in a region (a non-movement region) in which it is difficult for the user to move the cursor 55 unintentionally.

The second object to be operated may be a convenient name for explaining the second object to be operated while differentiating the second object to be operated from the first object to be operated. For example, an instruction associated with the first object to be operated and an instruction associated with the second object to be operated may be different from each other or may be the same instruction. The shape of a graphic indicating the first object to be operated and the shape of a graphic indicating the second object to be operated may be the same or may be different from each other. The second object to be operated is different from the first object to be operated which is displayed in other regions on the screen in that the second object to be operated is displayed in the non-movement region.

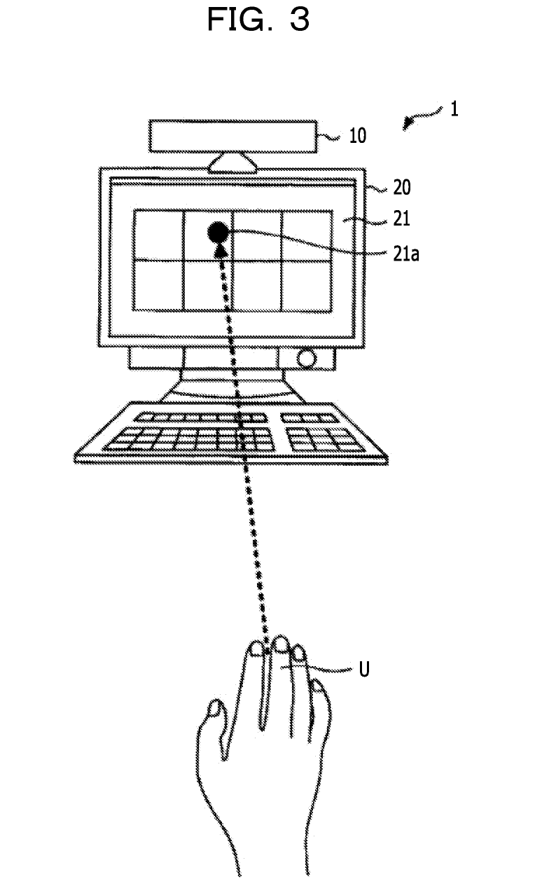

FIG. 3 depicts an example of a gesture UI device. A gesture UI device 1 may include, for example, terminals with a screen, such as a PC and a TV. The gesture UI device 1 may be a device that is capable of operating the screen of the PC, the TV, or the like by the movement of the user such as gestures. The movement made by the user to move the user's hand or part of the user's body to a particular position or with a particular movement trajectory (spatial gesture) may be called a “gesture”.

The body part of the user with which a gesture is made may be part or whole of the body of the user. The gesture may be the movement or direction of a hand, an arm, a leg, a trunk, a head, a line of sight, or the like. The gesture may be the movement of a mouth or voice.

The gesture UI device 1 includes a camera 10 and a display 20. A user interface (UI) on the screen for an input operation performed by a gesture, for example, input operation performed by a gesture is implemented by the camera 10 and software which runs on the display 20. The software portion may be implemented by, for example, hardware with an equivalent function.

The gesture UI device 1 may not depend on the mechanism of particular hardware. For example, the camera 10 may simply acquire the position of part of the body of the user. For example, the camera 10 may be used by being combined with a sensor such as a distance sensor, a monocular camera, or a stereo camera and an object tracking device. In place of the camera 10, the user may wear a terminal that acquires the position by using a gyro sensor, an acceleration sensor, ultrasound, or the like.

As the display 20, what performs screen display such as a monitor of a PC, a TV, a projector, or a head mounted display (HMD) may be used.

In the gesture UI device 1, the position of the hand of a user U is detected by the camera 10, for example. Based on the detected position of the hand, a cursor 21a is displayed in a position on the distant screen 21, the position corresponding to the position of the hand. By the displayed cursor 21a, GUI operation such as selection of an icon on the screen 21 is performed. In this way, the user U operates the distant screen by a gesture.

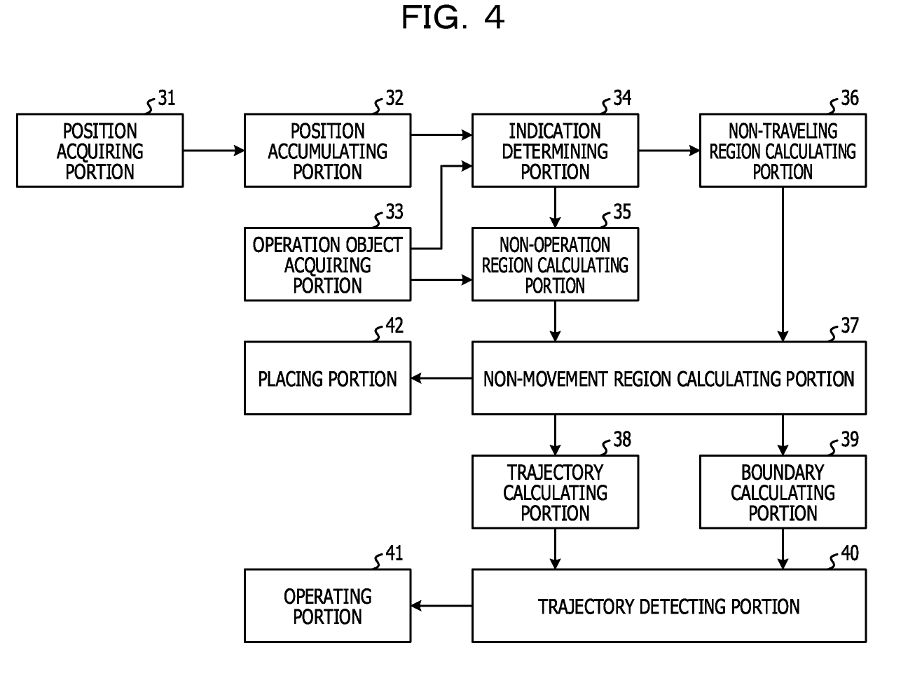

FIG. 4 depicts an example of a functional configuration of a gesture UI device.

The gesture UI device 1 includes a position acquiring portion 31, a position accumulating portion 32, an operation object acquiring portion 33, an indication determining portion 34, a non-operation region calculating portion 35, a non-traveling region calculating portion 36, a non-movement region calculating portion 37, a trajectory calculating portion 38, a boundary calculating portion 39, a trajectory detecting portion 40, an operating portion 41, and a placing portion 42.

The position acquiring portion 31 calculates an operation position (the position of the cursor) on the screen from the position of a pointing device or part of the body of the user such as the user's hand. The position accumulating portion 32 accumulates the position of the cursor acquired by the position acquiring portion 31 at fixed time intervals. The operation object acquiring portion 33 acquires the position of the first object to be operated which is displayed on the screen. For example, in FIG. 2, as an example of the first object to be operated, the button and menu 50 is displayed. An instruction associated with the first object to be operated may include, for example, execution of each application associated with each of the button and menu 50 and the icon.

The indication determining portion 34 determines whether or not the cursor indicates the region of the object 51 to be dragged. The non-operation region calculating portion 35 calculates a region (hereinafter referred to as a “non-operation region”) to which the cursor is expected not to move when the first object to be operated is operated based on the position of the first object to be operated such as the button and menu 50 on the screen and the position of the cursor.

The non-traveling region calculating portion 36 calculates a region (hereinafter referred to as a “non-traveling region) to which the cursor does not move without a sharp turn based on the velocity vector of the cursor (the orientation of the cursor) and the position of the cursor. The non-movement region calculating portion 37 calculates a region (hereinafter referred to as a “non-movement region”) to which the cursor is expected not to move based on the non-traveling region and the non-operation region. The placing portion 42 places the second object to be operated on the inside of the non-movement region including the boundary thereof.

An instruction associated with the second object to be operated may include, for example, start or end of a drag, deletion, copy, and so forth which are associated with the ring 60. For example, when a certain movement trajectory of the cursor is detected in the non-movement region, a change to a mode in which an instruction associated with the second object to be operated is executed is performed. When a certain movement trajectory is not detected, a mode change is not performed, and it is determined that operation of the cursor is cursor movement for the first object to be operated.

The trajectory calculating portion 38 calculates a movement trajectory of traveling in the region including the boundary of the non-movement region. The boundary calculating portion 39 calculates the boundary used to determine the cursor movement to the inside of the non-movement region including the boundary thereof.

The trajectory detecting portion 40 detects one or both of the movement trajectory of the cursor calculated by the trajectory calculating portion 38 and the movement trajectory of the cursor intersecting with the boundary detected by the boundary calculating portion 39. When the movement trajectory is detected, the operating portion 41 transmits an instruction, such as a drag, corresponding to the second object to be operated to the system or the application.

With the gesture UI device 1 described above, in the non-movement region calculating portion 37, the non-movement region to which the user is not able to move easily the cursor unintentionally is calculated. A gesture which is made in this non-movement region is set as a gesture for executing an instruction associated with the second object to be operated. A cursor movement for operating the first object to be operated such as the button and menu 50 and an intentional gesture for operating the second object to be operated are distinguished from each other. As a result, incorrect operation in gesture input is reduced.

The position acquiring portion 31 calculates an operation position (a cursor position) on the screen from the position of a pointing device or part of the body of the user such as the user's hand. For example, the position acquiring portion 31 acquires the position of the hand of the user or the position of the pointing device and calculates the position of the cursor on the screen. In the coordinate system of the hand, the normal direction of the screen of the display 20 (the display device) is set as a z-axis and the direction in which the hand gets away from the screen is set as positive. The horizontal direction in the plane of the screen is set as an x-axis and the vertical direction is set as a y-axis. In this coordinate system, the position acquiring portion 31 acquires the coordinates (xₕ, yₕ, zₕ) of the hand of the user. In accordance with the acquired position of the hand, the cursor coordinates (x, y) on the screen are calculated. In the coordinate system of the cursor, the horizontal direction in the plane of the screen is set as an x-axis (the right-hand direction is positive) and the vertical direction is set as a y-axis (the downward direction is positive). An example of a calculation formula for calculating the coordinates p of the cursor from the coordinates of the hand may be formula (1).

$$\{ \begin{matrix}x = {a}_{x} {x}_{h} + {b}_{x} \\ y = {a}_{y} {y}_{h} + {b}_{y}\end{matrix} \qquad ( 1 )$$

Here, aₓ, bₓ, a_{y}, b_{y} are each a constant of a real number and may be values that are experimentally determined based on the resolution of the screen, for example.

The position accumulating portion 32 accumulates the position acquired by the position acquiring portion 31 at fixed time intervals. The position accumulating portion 32 records the cursor coordinates p (x, y) calculated by the position acquiring portion 31 at fixed time intervals and accumulates the cursor coordinates p (x, y). The accumulated coordinates are used in calculating the traveling speed and direction of the cursor. The fixed time intervals may be 30 times per second, for example. The position accumulating portion 32 may accumulate the coordinates of the cursor or discard the coordinates of the cursor. For example, by discarding the coordinates of the cursor which were accumulated before a certain time, the coordinates of the cursor more than a certain amount may not be accumulated in the position accumulating portion 32.

The operation object acquiring portion 33 acquires a region w in which the first object to be operated such as the icon, the button, or the menu which is displayed on the screen is placed. The indication determining portion 34 determines whether or not the cursor indicates the region of the first object to be operated. In an example of the determination method, whether or not the time in which the cursor position p is included in the region w of the object to be operated is t second or more consecutively may be used as a condition. Here, t may be a positive constant which is determined experimentally.

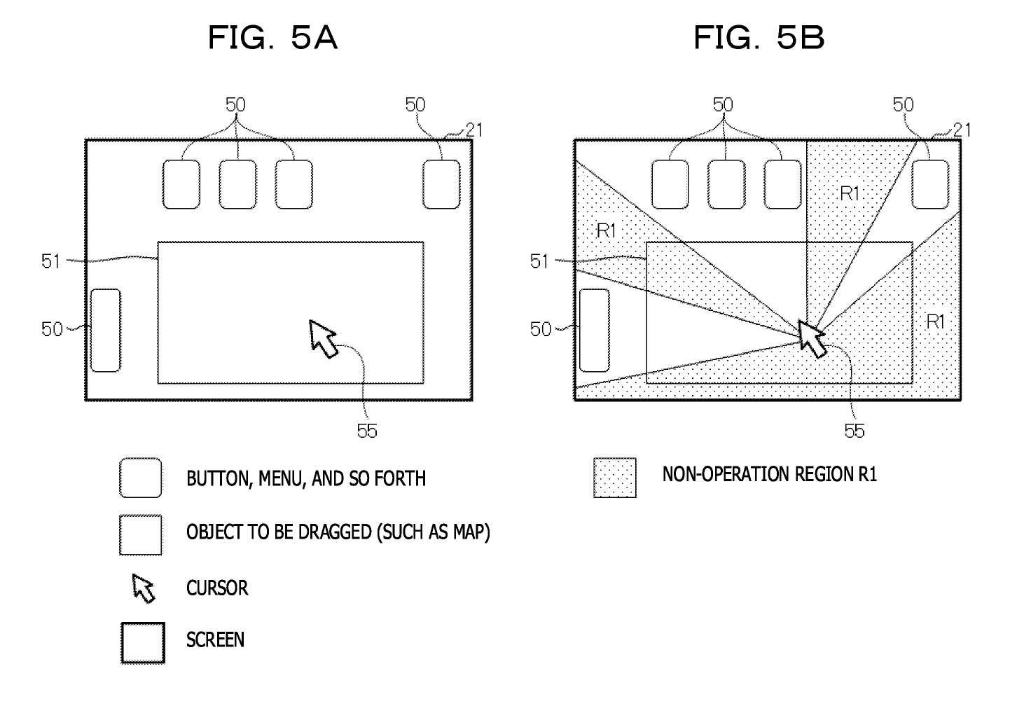

FIGS. 5A and 5B each depict an example of calculation of a non-operation region. In placement on the screen 21 depicted in FIG. 5A, the non-operation region calculating portion 35 calculates, based on the position of the button and menu 50 and the position of the cursor 55, a non-operation region R1 which is a region to which the cursor 55 is expected not to move when the button and menu 50 is operated. For example, as depicted in FIG. 5B, the non-operation region calculating portion 35 may calculate, as the non-operation region R1, a region located in a direction in which the button and menu 50 is not present when viewed from the current position of the cursor 55.

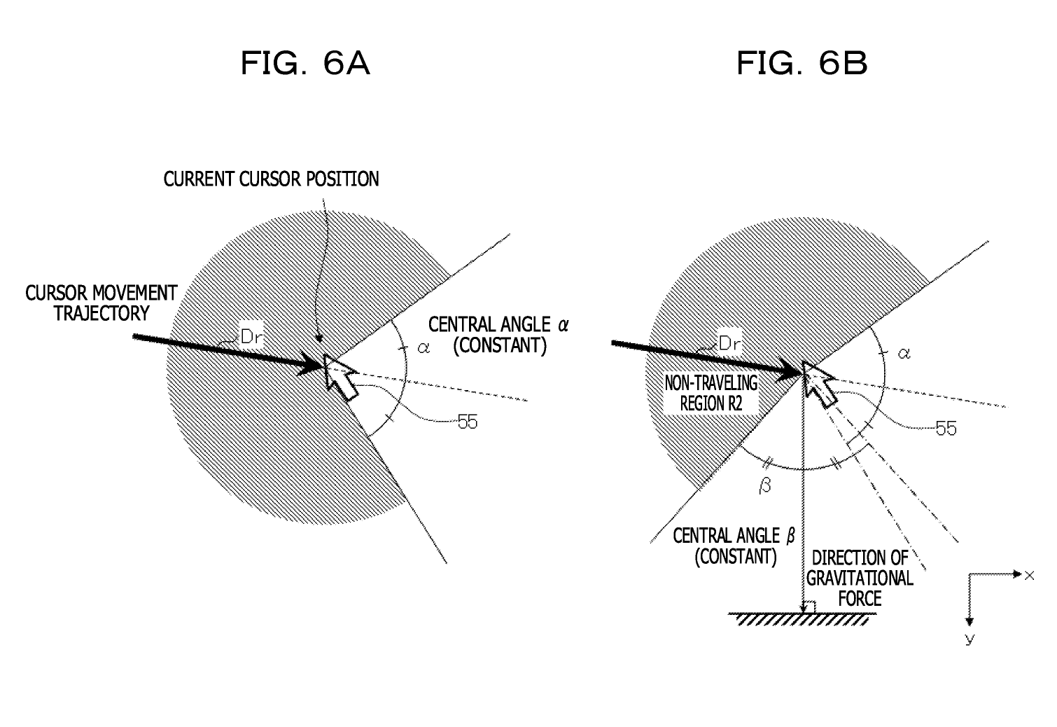

FIGS. 6A and 6B each depict an example of calculation of a non-operation region. FIG. 6A depicts a region to which the cursor does not move without a sharp turn. FIG. 6B depicts a region which is a region to which the cursor does not move without a sharp turn, the region which is not located in the direction of gravitational force. The non-traveling region calculating portion 36 calculates a non-traveling region R2 which is a region to which the cursor 55 is expected not to travel without a sharp turn based on the velocity vector of the cursor 55 and the position of the cursor 55. For example, in FIG. 6A, the non-traveling region calculating portion 36 calculates, as the non-traveling region R2, a region located in a direction opposite to the current direction of movement of the cursor, the direction of movement derived from a movement trajectory Dr of the cursor 55. For example, a region from which regions forming an angle of α (a constant) on both sides with the current direction of movement of the cursor as a center are removed is calculated as a region opposite to the current direction of movement of the cursor, for example, the non-traveling region R2.

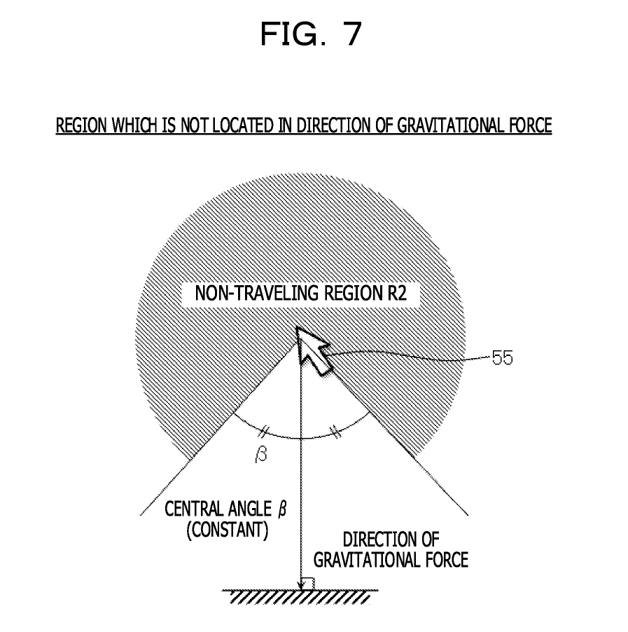

In a spatial gesture, the hand is often lowered in order to rest the hand. As a gesture made at this time, the hand may be often moved in a positive direction of the y-axis of the screen. Therefore, the non-traveling region calculating portion 36 may calculate the non-traveling region R2 based on the orientation of the cursor and the direction of gravitational force. For example, as depicted in FIG. 6B, in addition to a region other than the non-traveling region R2 depicted in FIG. 6A, a region from which a region in the direction of gravitational force (a region of central angle α×2+a region of central angle β (a constant)×2 with respect to the positive direction of the y-axis) is removed may be calculated as the non-traveling region R2. FIG. 7 depicts an example of calculation of a non-operation region. When the cursor 55 is halted, as depicted in FIG. 7, the non-traveling region calculating portion 36 may calculate, as the non-traveling region R2, a region from which a region in the direction of gravitational force (for example, a region of central angle β (a constant)×2 with respect to the positive direction of the y-axis) is removed.

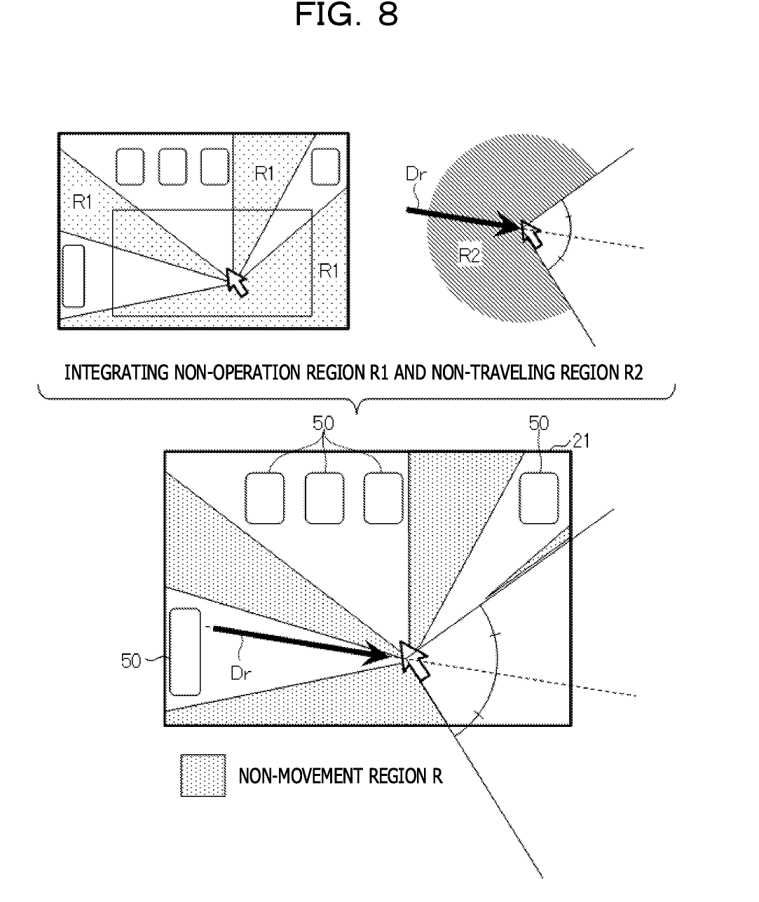

The non-movement region calculating portion 37 calculates a non-movement region R which is a region to which the cursor is expected not to move unintentionally by integrating the non-operation region R1 and the non-traveling region R2. FIG. 8 depicts an example of calculation of a non-operation region. For example, as depicted in FIG. 8, the non-movement region calculating portion 37 may calculate, as the non-movement region R, a region (a common region) in which the two regions, for example, the non-operation region R1 and the non-traveling region R2, overlap one another. The calculation of the non-operation region R1 and the non-traveling region R2 depends on the direction from the position of the cursor 55 and may not depend on the distance. As a result, the non-operation region R1 and the non-traveling region R2 may be calculated based on the non-operation direction and the non-traveling direction.

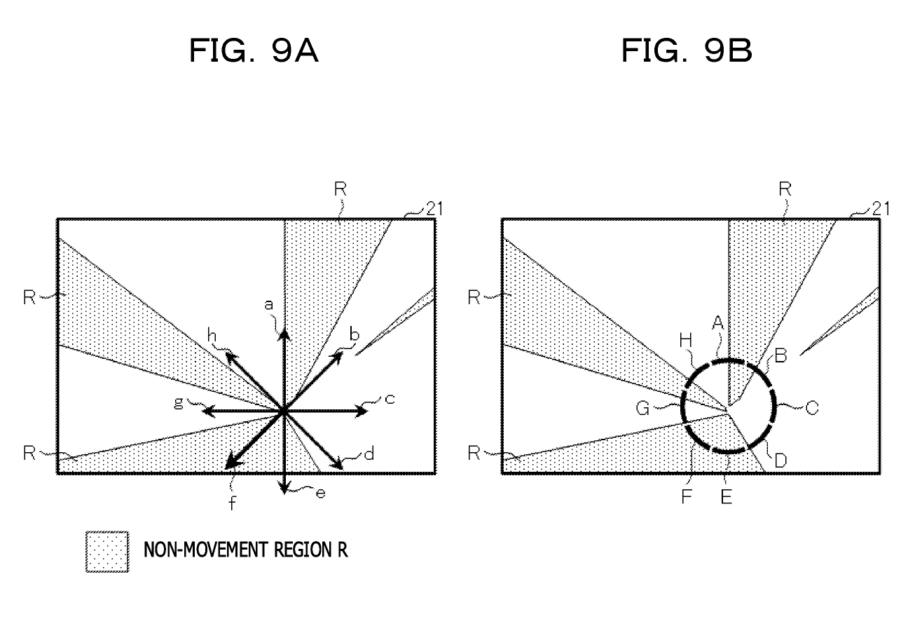

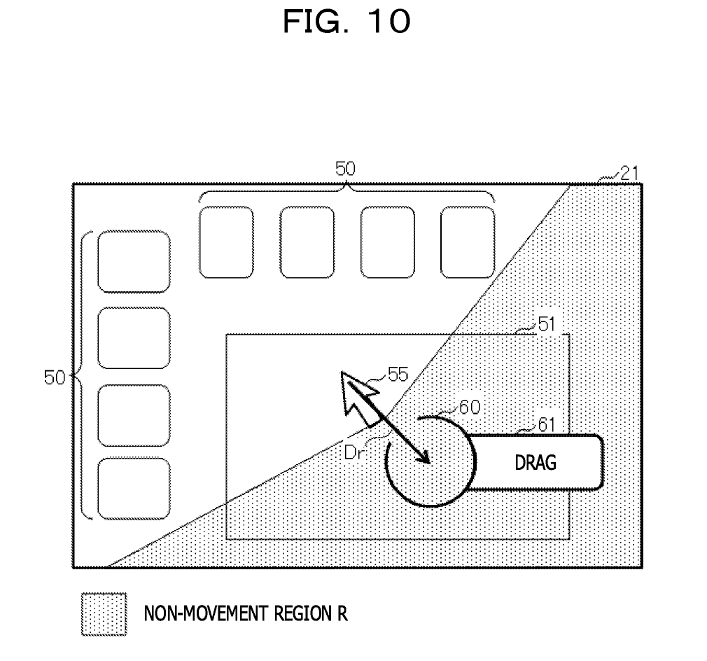

FIG. 9A depicts an example of trajectory calculation. FIG. 9B depicts an example of boundary calculation. FIG. 10 depicts an example of display of a movement trajectory. The placing portion 42 places the second object to be operated on the boundary or the inside of the non-movement region R. As depicted in FIG. 10, the second object to be operated may be a graphic such as the ring 60 having an opening that guides the direction of movement of the cursor 55. An instruction associated with the second object to be operated of FIG. 10 may be a drag. As the second object to be operated, in place of the ring 60, an image of a portion 61 in which drag is displayed may be displayed. The second object to be operated may also be a graphic having a line that guides the direction of movement of the cursor 55.

The trajectory calculating portion 38 calculates a movement trajectory of the cursor traveling on the boundary or the inside of the non-movement region R, for example, a movement trajectory of the cursor included in the non-movement region R. The boundary calculating portion 39 calculates a boundary for determining the cursor movement to the inside of the non-movement region R, for example, a boundary included in the non-movement region R.

For example, one or more of at least one of the movement trajectory which is calculated by the trajectory calculating portion 38 and the boundary which is calculated by the boundary calculating portion 39 may be calculated.

The movement trajectory which is calculated by the trajectory calculating portion 38 may be a linear movement trajectory in a particular direction, for example. As depicted in FIG. 9A, the direction may be one or more of a finite number of candidates (here, eight candidates indicated by arrows a to h of the movement trajectories). For example, the trajectory calculating portion 38 determines whether or not the candidate of the movement trajectory is included in the non-movement region R and calculates one or more of the candidates included in the non-movement region R as the movement trajectory. In FIG. 9A, for example, the arrows a, e, and f of the movement trajectories included in the non-movement region R may be a second object to be operated. For example, when only the arrow e of the movement trajectory is displayed as the second object to be operated, if a gesture following the arrow e of the movement trajectory is detected, a mode change is performed and an instruction associated with the second object to be operated is executed. For example, if a gesture following the movement trajectory b is detected, since the movement trajectory b is a cursor movement which is not included in the non-movement region R, a mode change is not performed and the cursor 55 moves in that direction. The placing portion 42 may place at least any one of the arrows a, e, and f of the movement trajectories included in the non-movement region R on the screen 21 as an example of the second object to be operated.

The boundary which is calculated by the boundary calculating portion 39 may be a concyclic arc whose center is located in the position of the cursor. As depicted in FIG. 9B, the boundary which is calculated by the boundary calculating portion 39 may be one or more of an infinite number of candidates (here, eight candidates: arcs A to H each indicating the boundary). In this case, the boundary calculating portion 39 determines whether or not the candidate of the boundary is included in the non-movement region R and calculates the candidate with the largest part included in the non-movement region R as an arc indicating the boundary. In FIG. 9B, for example, at least any one of the arcs E and F may be the second object to be operated. The placing portion 42 may place at least any one of the arcs E and F included in the non-movement region R on the screen 21 as an example of the second object to be operated.

The trajectory detecting portion 40 detects the movement trajectory of the cursor, the movement trajectory coinciding with the movement trajectory calculated by the trajectory calculating portion 38, or the movement trajectory of the cursor, the movement trajectory intersecting with the boundary calculated by the boundary calculating portion 39. In determining whether or not the movement trajectory coincides with the movement trajectory calculated by the trajectory calculating portion 38, an existing trajectory recognition technique may be used.

In the trajectory detecting portion 40, detection may be invalidated if the movement trajectory of the cursor is not detected for a fixed period of time. In this case, detection may be validated again if the cursor moves and indicates the first object to be operated again.

When the movement trajectory of the cursor which coincides with the calculated movement trajectory or the movement trajectory of the cursor which intersects with the calculated boundary is detected, the operating portion 41 determines that the mode has been switched based on the movement of the cursor (a mode change has been performed). The operating portion 41 executes an instruction of the second object to be operated after the mode change. For example, the operating portion 41 transmits, for example, start or end of a drag of an object, copy or deletion of an object, and so forth to the system or the application as an instruction associated with the second object to be operated. The placing portion 42 may display the second object to be operated in such a way as to give the user the direction of movement of the cursor. For example, the placing portion 42 may display, on the screen 21, the movement trajectory detected by the trajectory detecting portion 40. For example, the placing portion 42 may display the detected movement trajectory on the screen 21 without change. For example, in displaying one movement trajectory, the placing portion 42 may display the arrow f of FIG. 9A on the screen 21 or the arc F of FIG. 9B on the screen 21. In displaying a plurality of movement trajectories, the placing portion 42 may display two or more of the arrows a, e, and f of FIG. 9A on the screen 21 or the arcs E and F of FIG. 9B on the screen 21.

As a result of the placing portion 42 displaying the ring 60 with a cut depicted in FIG. 10, the movement trajectory Dr of the cursor 55 for performing a mode change may be given to the user. In FIG. 10, when the cursor 55 enters the ring 60 through the opening of the ring 60 which is the second object to be operated, a drag instruction associated with the ring 60 which is displayed next to the ring 60, is executed. The placing portion 42 displays the opening of the ring 60 in such a way that the movement trajectory Dr which the cursor 55 follows when entering the ring 60 through the cut coincides with the movement trajectory detected by the trajectory detecting portion 40. A mode change is performed when the user moves the cursor 55 to the inside of the ring 60 through the cut as the user is induced to do so, and a drag instruction associated with the ring 60 which is the second object to be operated is executed. As described above, when the second object to be operated is a graphic having an opening or a line that gives the user the direction of movement of the cursor, the user may easily understand the operation of a mode change and learn the operation with ease.

The placing portion 42 may display the non-movement region R depicted in FIG. 8 without change as a graphic indicating the second object to be operated. For example, the non-movement region R may be displayed as a see-through region in order to make it easy to view the whole of the screen 21. In this case, for the movement of the cursor 55 passing across the boundary of the non-movement region R and moving into the non-movement region R from the outside thereof, an instruction such as start or end of a drag of an object to be dragged may be executed by the trajectory detecting portion 40.

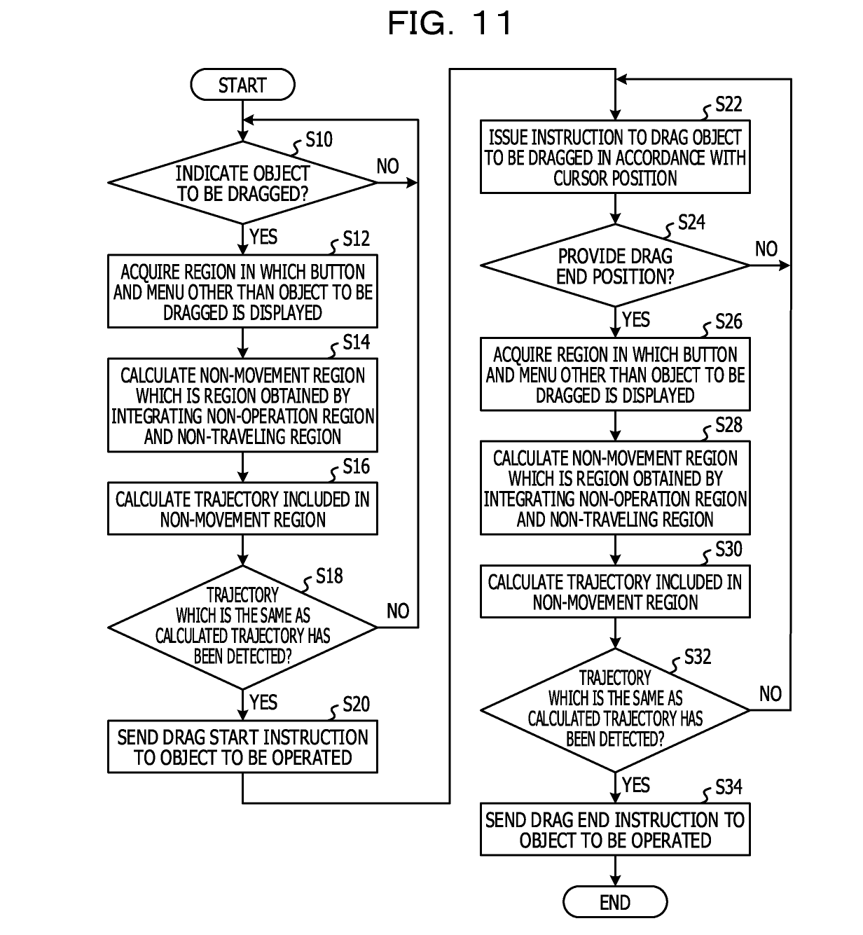

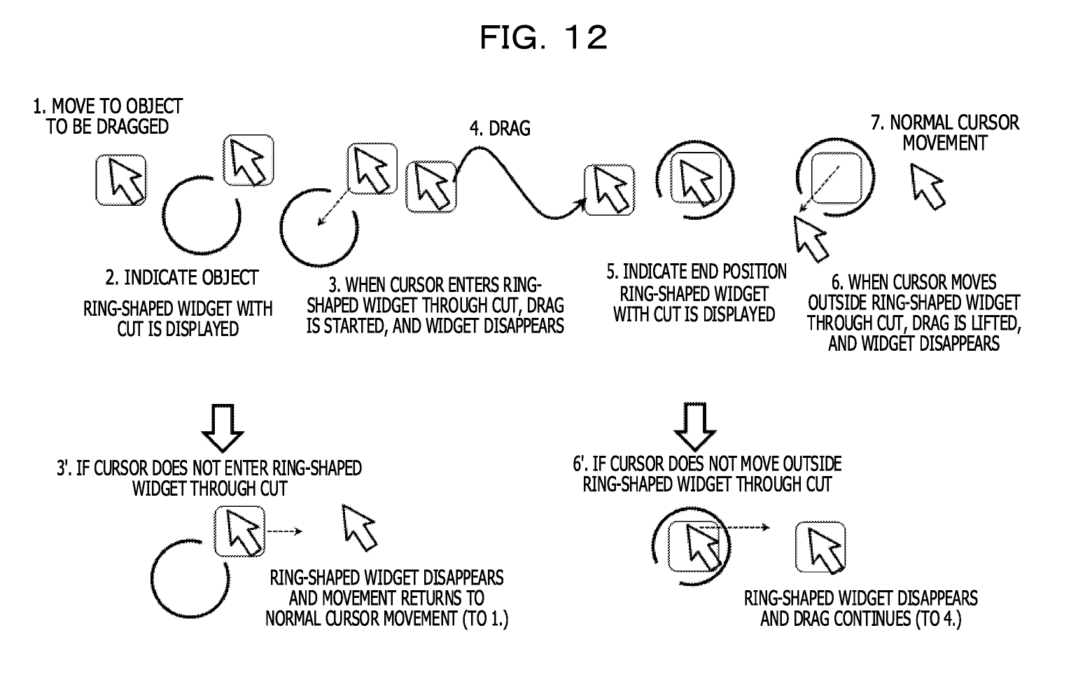

FIGS. 11 and 12 each depict an example of a processing of issuing drag instruction.

The indication determining portion 34 determines whether or not an object to be dragged has been indicated (operation S10) and repeats operation S10 until an object to be dragged is indicated. As depicted in “1” of FIG. 12, if the cursor moves to an object to be dragged and it is determined that the object to be dragged has been indicated, the non-operation region calculating portion 35 acquires a region in which the button and menu 50 other than the object to be dragged is placed (operation S12). The non-operation region calculating portion 35 calculates a non-operation region based on the region in which the button and menu 50 is placed and the position of the cursor at that time (operation S14). For example, when the object 51 to be dragged of FIG. 5A is indicated, a region in which the button and menu 50 other than the object 51 to be dragged is placed is acquired and the non-operation region R1 is calculated.

The non-traveling region calculating portion 36 acquires the position of the cursor and the direction of the cursor and calculates a non-traveling region (operation S14). For example, as depicted in FIG. 6A, the non-traveling region calculating portion 36 calculates the non-traveling region R2. As depicted in FIG. 6B and FIG. 7, the non-traveling region calculating portion 36 may calculate the non-traveling region R2 based on the position of the cursor and the direction of the cursor and the direction of gravitational force.

The non-movement region calculating portion 37 calculates a non-movement region which is a region obtained by integrating the non-operation region R1 and the non-traveling region R2 (operation S14). For example, as depicted in FIG. 8, a region in which the non-operation region R1 and the non-traveling region R2 overlap one another is set as the non-movement region R. The non-movement region R may be a region to which the cursor is expected not to move unintentionally. Therefore, in screen operation by a gesture, the second object to be operated is placed in the non-movement region R.

The trajectory calculating portion 38 calculates the trajectory of the cursor included in the non-movement region R (operation S16). The calculated trajectory of the cursor may include the trajectory of the cursor on the boundary of the non-movement region R.

The trajectory detecting portion 40 determines whether or not a movement trajectory which is substantially the same as the calculated movement trajectory has been detected (operation S18). If it is determined that a movement trajectory which is substantially the same as the calculated movement trajectory is not detected, the processing goes back to operation S10. If a movement trajectory which is substantially the same as the calculated movement trajectory has been detected, the operating portion 41 sends a drag instruction (start) associated with the second object to be operated to the application (operation S20). For example, as depicted in “2” of FIG. 12, the ring 60 with an opening in part thereof may be placed in the non-movement region R. As depicted in “3” of FIG. 12, when the cursor enters the ring 60 through the opening, the trajectory detecting portion 40 determines that a movement trajectory which is substantially the same as the calculated trajectory of the cursor has been detected. Since an instruction to start or end a drag is associated with the second object to be operated depicted as the ring 60, a drag instruction is started concurrently with the detection, and the display of the ring 60 may disappear.

Back in FIG. 11, the operating portion 41 issues an instruction to drag the object to be dragged in accordance with the position of the cursor (operation S22). As depicted in “4” of FIG. 12, the cursor moves in a state in which the instruction to perform a drag is issued. If it is detected that a drag end position is provided by the trajectory detecting portion 40 (operation S24), the non-operation region calculating portion 35 acquires a region in which the button and menu 50 other than the object to be dragged is placed (operation S26). The non-operation region calculating portion 35 calculates a non-operation region based on the region in which the button and menu 50 is placed and the position of the cursor at that time (operation S28). The non-traveling region calculating portion 36 acquires the position of the cursor and the direction of the cursor and calculates a non-traveling region (operation S28). The non-movement region calculating portion 37 calculates a non-movement region which is a region obtained by integrating the non-operation region R1 and the non-traveling region R2 (operation S28).

The trajectory calculating portion 38 calculates the trajectory of the cursor included in the non-movement region R (operation S30). The trajectory detecting portion 40 determines whether or not a movement trajectory which is substantially the same as the calculated movement trajectory has been detected (operation S32). If it is determined that a movement trajectory which is substantially the same as the calculated movement trajectory is not detected, the processing goes back to operation S22. If a movement trajectory which is substantially the same as the calculated movement trajectory has been detected, the operating portion 41 sends a drag instruction (end) associated with the second object to be operated to the application (operation S34). For example, the ring 60 depicted in “5” of FIG. 12 is displayed in the non-movement region R, and, when the cursor moves outside the ring 60 through the opening, the trajectory detecting portion 40 determines that a movement trajectory which is substantially the same as the calculated movement trajectory has been detected. Therefore, as depicted in “6” of FIG. 12, the drag instruction is ended concurrently with the detection, the display of the ring 60 disappears, and normal cursor movement may be performed.

As depicted in “3” of FIG. 12, when the cursor does not enter the ring 60 through the opening (the cut), the display of the ring 60 disappears, and the movement may return to normal cursor movement. Likewise, as depicted in “6” of FIG. 12, when the cursor moves outside the ring 60 by using a route other than the opening (the cut), the display of the ring 60 disappears, and the drag instruction state may continue.

Even when there is no opening, since an instruction to start a drag is provided as a result of the cursor entering the ring 60, the ring 60 depicted in “3” of FIG. 12 may not have an opening. On the other hand, since an instruction to end a drag is provided as a result of the cursor moving outside of the ring 60 by using the opening, the ring 60 depicted in “5” of FIG. 12 may have an opening.

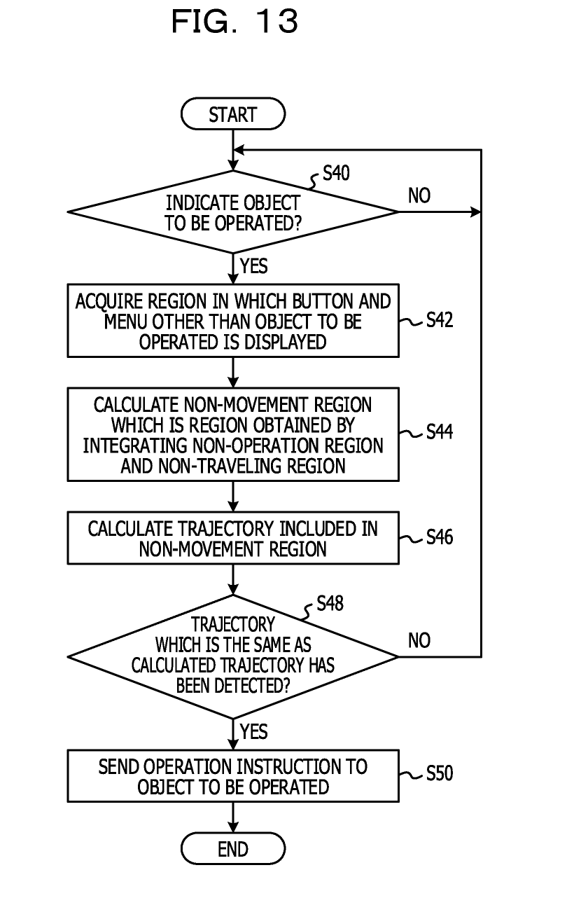

FIG. 13 depicts an example of a processing of issuing deletion instruction.

The indication determining portion 34 determines whether or not an object to be deleted has been indicated (operation S40) and repeats the processing in operation S40 until an object to be deleted is indicated. If it is determined that an object to be deleted has been indicated, the non-operation region calculating portion 35 acquires a region in which the button and menu 50 other than the object to be deleted is placed (operation S42). The non-operation region calculating portion 35 calculates a non-operation region based on the region in which the button and menu 50 is placed and the position of the cursor at that time (operation S44). The non-traveling region calculating portion 36 acquires the position of the cursor and the direction of the cursor and calculates a non-traveling region (operation S44).

The non-movement region calculating portion 37 calculates a non-movement region which is a region obtained by integrating the non-operation region R1 and the non-traveling region R2 (operation S44). The trajectory calculating portion 38 calculates the trajectory of the cursor included in the non-movement region (operation S46).

The trajectory detecting portion 40 determines whether or not a movement trajectory which is substantially the same as the calculated movement trajectory has been detected (operation S48). If it is determined that a movement trajectory which is substantially the same as the calculated movement trajectory is not detected, the processing goes back to operation S40. If a movement trajectory which is substantially the same as the calculated movement trajectory has been detected, the operating portion 41 sends an operation instruction (deletion) associated with the second object to be operated to the application (operation S50). Therefore, the second object to be operated is deleted, the display of the ring 60 disappears, and normal cursor movement is performed.

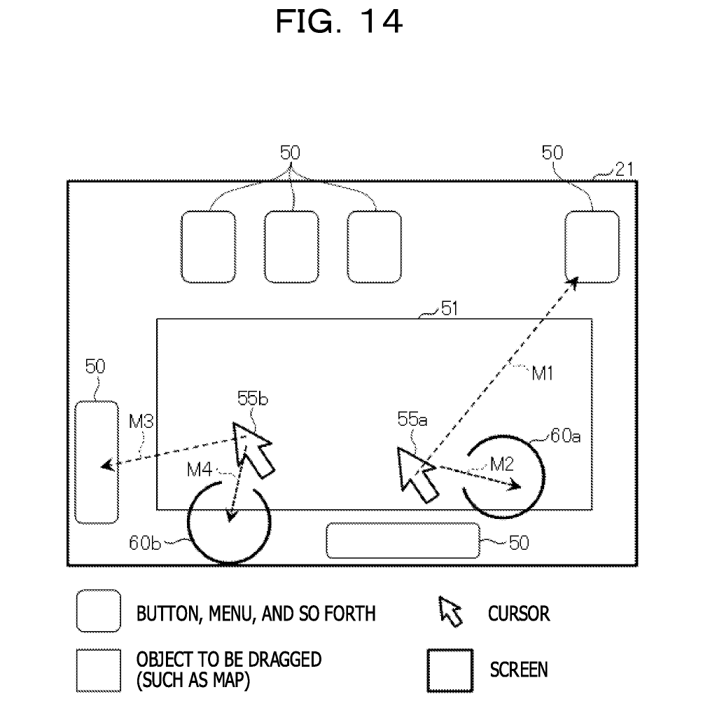

With the gesture UI processing, as depicted in FIG. 14, with respect to the button and menu 50 or the like displayed on the screen, the ring 60 that operates the object 51 to be dragged is placed inside the non-movement region R or on the boundary thereof. Since the second object to be operated is placed in the non-movement region R, the user may not move the cursor to the position of the second object to be operated unless the user intends to operate the second object to be operated. For example, since a ring 60a of FIG. 14 is displayed in a non-movement region R, the user may not move a cursor 55a in the direction of a movement trajectory M2 unless the user intends to do so. Therefore, as for the cursor 55a, a movement trajectory M1 of the cursor for selecting the button and menu 50 and the movement trajectory M2 of the cursor for executing a drag instruction associated with the ring 60a may differ from each other. Likewise, as for a cursor 55b of FIG. 14, a movement trajectory M3 of the cursor for selecting the button and menu 50 and a movement trajectory M4 of the cursor for selecting a drag instruction associated with the ring 60a may differ from each other.

With the gesture UI device, in input by a gesture, a gesture for cursor movement for the first object to be operated displayed on the screen 21 and a gesture for executing an instruction associated with the second object to be operated may be distinguished from each other. As a result, incorrect operation may be reduced in input by a gesture. In the gesture UI device, a sensor and a recognition device other than minimum sensor and recognition device which are desired for a spatial gesture may not be added. A complicated gesture may not be used and a simple gesture is used, whereby incorrect operation in gesture input may be reduced.

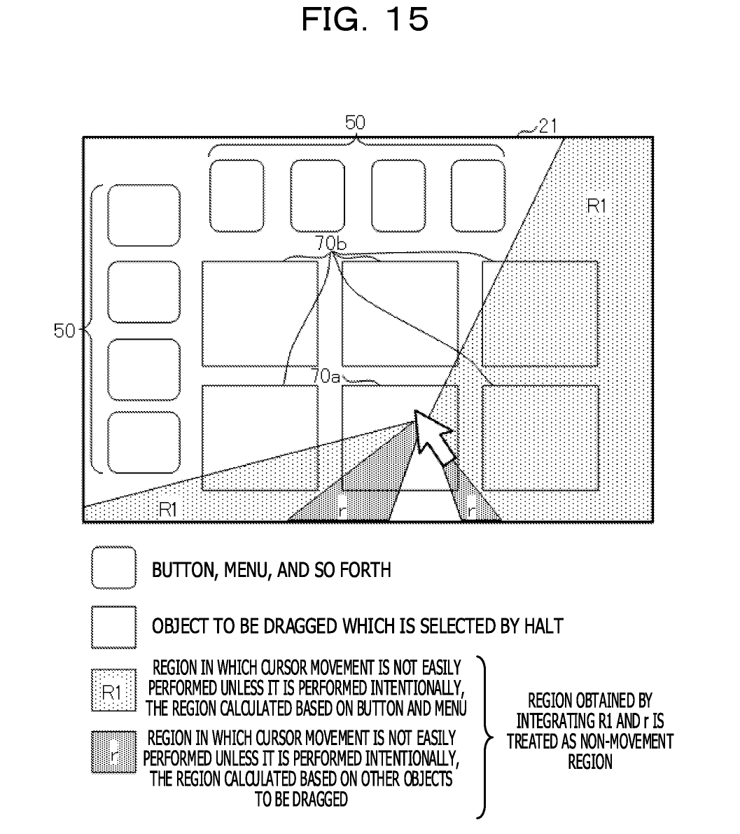

FIG. 15 to FIGS. 17A and 17B each depict an example of calculation of a non-movement region.

In FIG. 15, a plurality of objects 70a and 70b to be dragged are displayed on the screen 21. For example, the non-movement region R may be calculated by regarding, as the first object to be operated just like the button and menu 50, the object to be dragged 70b other than the object to be dragged 70a which the cursor 55 indicates. For example, the non-operation region calculating portion 35 specifies a region in which cursor movement is easily performed to operate the button and menu 50 based on the region in which the button and menu 50 is placed and calculates other regions as the non-operation region R1 in which cursor movement is not easily performed unless it is performed intentionally. The non-operation region calculating portion 35 specifies a region in which cursor movement is easily performed to operate the object to be dragged 70b based on the region in which the object to be dragged 70b which the cursor does not indicate is placed, and calculates other regions as a non-operation region r in which cursor movement is not easily performed unless it is performed intentionally. The non-movement region calculating portion 37 sets a region which is the sum of the non-operation region R1 and the non-operation region r as a non-movement region. Therefore, also in FIG. 15, in input by a gesture, a gesture for cursor movement for the first object to be operated including the object to be dragged and a gesture for executing an instruction associated with the second object to be operated may be distinguished from each other. Incorrect operation in input by a gesture may be reduced.

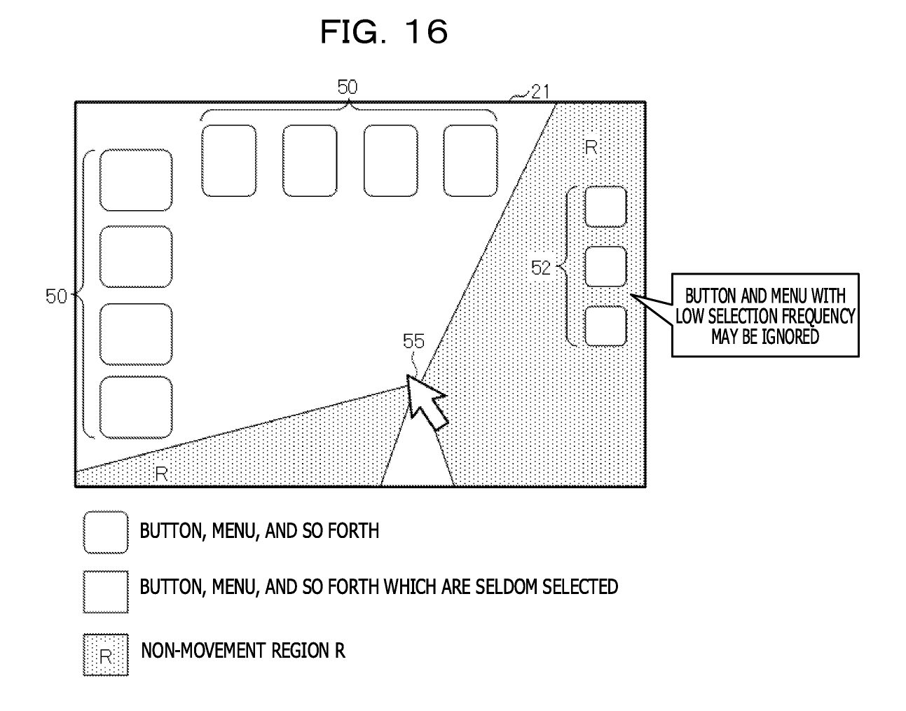

In FIG. 16, button and menus 50 and 52 having different selection frequencies are displayed on the screen 21. The selection frequency of the button and menu 52 is lower than the selection frequency of the button and menu 50.

For example, a non-movement region R may be calculated with no consideration for the button and menu 52 with a low selection frequency (the button and menu 52 which is seldom selected, for example). The button and menu 52 with a low selection frequency may be specified in advance. The non-operation region calculating portion 35 calculates the non-operation region R1 with no consideration for the specified button and menu 52. Therefore, the non-operation region R1 may include a cursor movement region which is easily used to select the button and menu 52 from the position of the cursor 55. The button and menu 52 is seldom selected. Therefore, in input by a gesture, a gesture for cursor movement for the first object to be operated and a gesture for executing an instruction associated with the second object to be operated may be distinguished from each other. Incorrect operation may be reduced in input by a gesture.

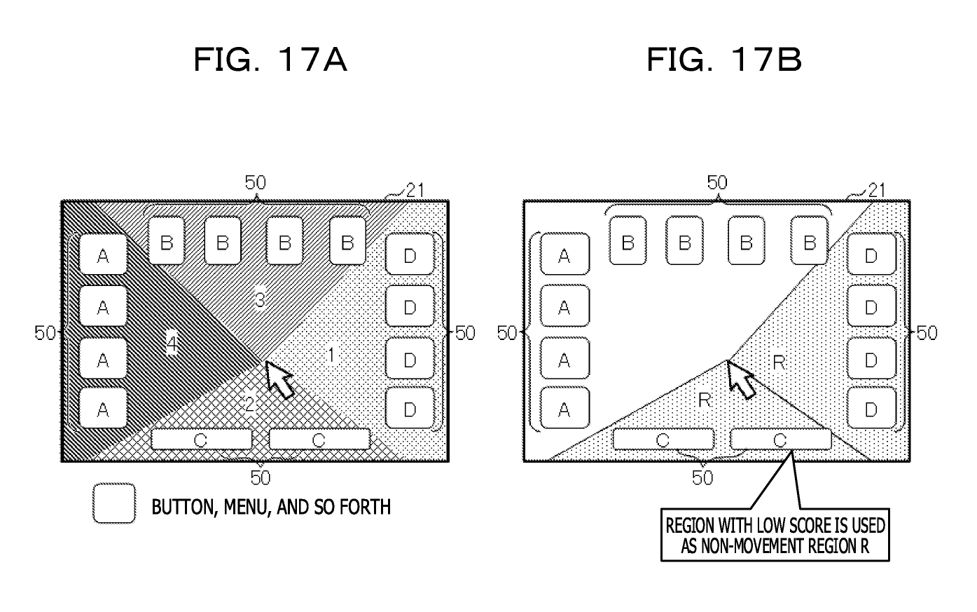

As depicted in FIGS. 17A and 17B, buttons and menus 50 having different selection frequencies are displayed on the screen 21. Although the selection frequency of each button and menu 50 is a fixed value in FIG. 16, the selection frequency of each button and menu 50 may be set at a variable value in FIGS. 17A and 17B.

As depicted in FIGS. 17A and 17B, when the buttons and menus 50 each being the first object to be operated are located all over the screen 21, a non-operation region becomes empty, which may make it difficult for the trajectory calculating portion 38 and the boundary calculating portion 39 to perform calculation of the movement trajectory and the boundary, respectively. Therefore, a score which increases in accordance with the selection frequency of the first object to be operated may be counted for each region of the screen. In FIG. 17A, the selection frequency of the first object to be operated is divided into levels from A with the highest frequency to D with the lowest frequency, for which scores from 4 to 1 are respectively set. For example, as depicted in FIG. 17A, the buttons and menus 50 are classified into buttons and menus A, B, C, and D in descending order of selection frequency. For example, as depicted in FIG. 17B, the non-operation region R1 may be calculated with no consideration for the buttons and menus C and D whose selection frequencies are relatively lower than the selection frequencies of the buttons and menus A and B. For example, the non-operation region R1 may be calculated with no consideration only for the button and menu D with the lowest selection frequency. For example, the non-operation region R1 may be calculated with no consideration for the buttons and menus B, C, and D other than the button and menu A with the highest selection frequency.

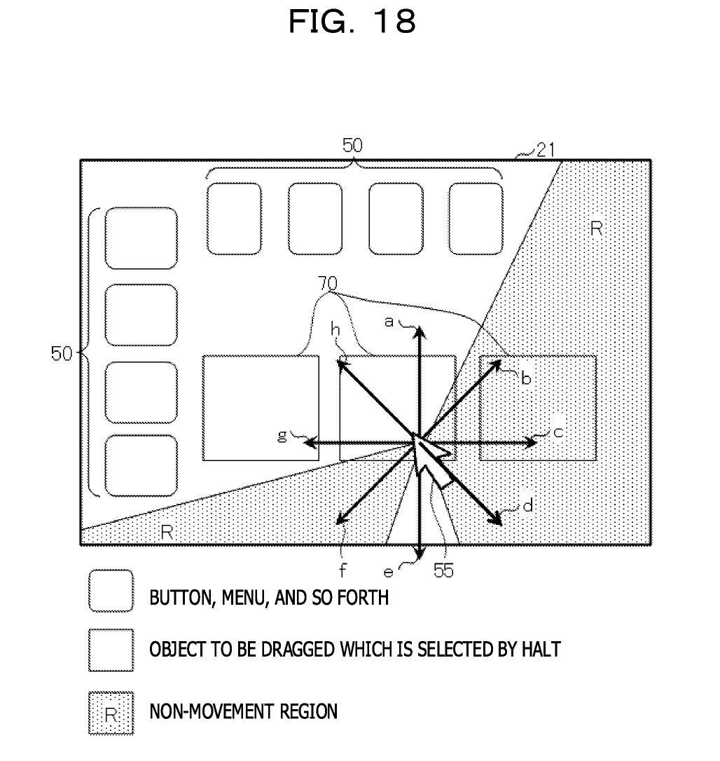

FIG. 18 depicts an example of display of a trajectory calculation result. In FIG. 18, as a result of trajectory calculation, arrows a to h are displayed in eight directions from the position of the cursor 55. The priority is assigned to the arrows, each representing the movement trajectory, and the arrow with high priority is displayed.

If the buttons and menus 50 are placed unevenly, the movement trajectory calculation result becomes substantially uniform, which makes it easier for the user to learn screen operation by a gesture. For example, the priority of the arrows b, c, d, and f of the movement trajectory in the non-movement region R depicted in FIG. 18 is set as follows: the arrow d has the highest priority, followed by the arrows c, b, and f. In this case, the placing portion 42 may place the arrow d of the movement trajectory with the highest priority on the screen and may not place the other movement trajectories c, b, and f. For example, the method of display of the arrow of the movement trajectory may be changed to make it easier for the user to learn. The line of the arrow may be made thicker, the color of the line of the arrow may be heightened, or the size of the arrow may be increased in descending order of priority.

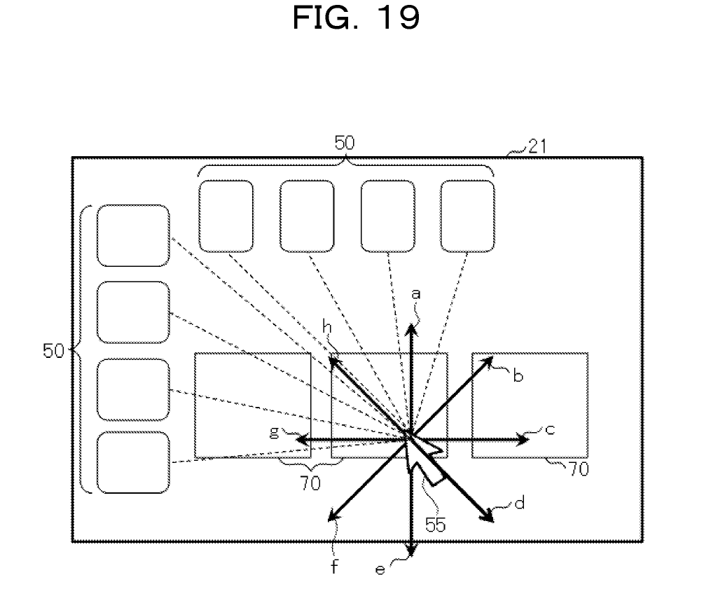

FIG. 19 depicts an example of trajectory calculation. In FIG. 19, a simplified trajectory calculation method which is adopted when the movement trajectory is limited is depicted. A dotted line of FIG. 19 indicates a representative line (a dotted line) of the movement trajectory of the cursor observed when each button and menu 50 displayed on the screen 21 is selected. As indicated by the representative line, if the movement trajectory calculated by the trajectory calculating portion 38 is simple and the candidate is limited, the non-operation region R1 and the non-traveling region R2 may not be calculated. An equivalent calculation result may be obtained by a simple calculation method.

For example, the non-movement region calculating portion 37 calculates in advance a movement trajectory to the first object to be operated such as the button and menu 50 based on the current position of the cursor 55. For example, when a linear movement trajectory indicated by the representative line of FIG. 19 is calculated, in selecting each button and menu 50, the non-operation region calculating portion 35 may calculate a region obtained by providing a range of about 30° to the representative line as a region to which the cursor 55 is expected to move.

The non-movement region calculating portion 37 removes, from the candidates, an arrow of a trajectory candidate similar to the calculated movement trajectory to the button and menu 50. The non-movement region calculating portion 37 removes an arrow of a trajectory candidate in a direction similar to the current traveling direction of the cursor. One arrow of a movement trajectory may be selected from the remaining trajectory candidates. For example, an arrow d of a movement trajectory depicted in FIG. 19 may be selected. In this case, as the second object to be operated, a ring 60 having an opening in the position of the arrow d may be placed.

By detecting the movement trajectory of the cursor in the non-movement region, a movement trajectory which is sufficiently different from the movement trajectory to the button and menu 50 may be adopted. Therefore, in input by a gesture, a gesture for cursor movement for operating the first object to be operated and a gesture for executing an instruction associated with the second object to be operated may be distinguished from each other. Incorrect operation in input by a gesture may be reduced. When the movement trajectory is limited, since the processing of the non-operation region calculating portion 35, the non-traveling region calculating portion 36, and the trajectory calculating portion 38 is performed in a simplified manner, the speed of processing from gesture input to the display of the second object to be operated may be enhanced.

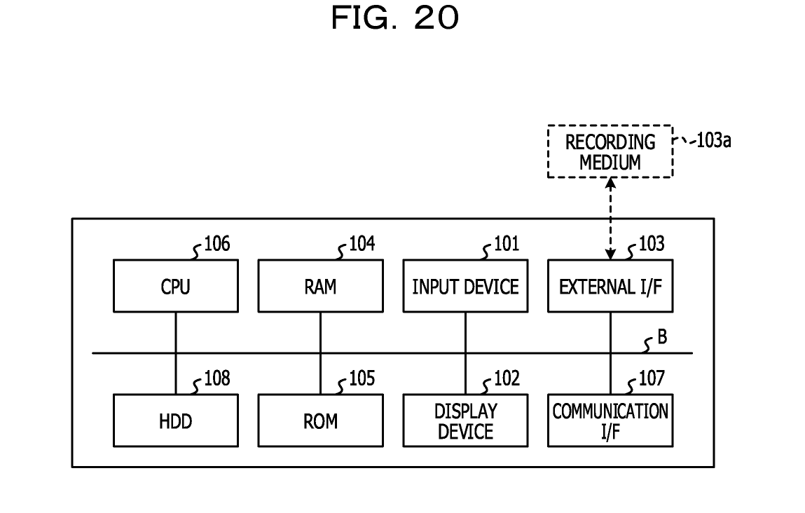

FIG. 20 depicts an example of a hardware configuration of a gesture UI device. The gesture UI device 1 includes an input device 101, a display device 102, an external I/F 103, random-access memory (RAM) 104, read-only memory (ROM) 105, a central processing unit (CPU) 106, a communication I/F 107, and a hard disk drive (HDD) 108. The portions are coupled to one another by a bus B.

The input device 101 includes a camera 10, a keyboard, a mouse, and so forth and may be used to input operations to the gesture UI device 1. The display device 102 includes a display 20 and performs, for example, operation of the button and menu 50 on the screen in accordance with gesture input performed by the user and displays the result thereof.

The communication I/F 107 may be an interface that couples the gesture UI device 1 to a network. The gesture UI device 1 is capable of performing communication with other devices via the communication I/F 107.

The HDD 108 may be a nonvolatile storage device that stores a program and data. The program and data to be stored may include an operating system (OS) which is basic software controlling the whole of the device, application software that offers various functions on the OS, and so forth. The HDD 108 stores a program that is executed by the CPU 106 to perform indication determination processing, non-operation region calculation processing, non-traveling region calculation processing, non-movement region calculation processing, trajectory calculation processing, boundary calculation processing, trajectory detection processing, and processing to operate an object to be operated.

The external I/F 103 may be an interface between the gesture UI device 1 and an external device. The external device includes a recording medium 103a and so forth. The gesture UI device 1 performs any one of reading and writing of data from and to the recording medium 103a or both reading and writing of data from and to the recording medium 103a via the external I/F 103. The recording medium 103a may include a compact disk (CD), a digital versatile disk (DVD), an SD memory card, universal serial bus (USB) memory, and so forth.

The ROM 105 may be a nonvolatile semiconductor memory (storage device), in which a program and data such as a basic input/output system (BIOS) which is executed at the time of start-up, OS settings, and network settings are stored. The RAM 104 may be a volatile semiconductor memory (storage device) that temporarily holds a program and data. The CPU 106 may be an arithmetic unit that implements control of the whole of the device and built-in functions by reading a program or data in the RAM from the storage device (such as the “HDD” or the “ROM”) and performing processing.

The indication determining portion 34, the non-operation region calculating portion 35, the non-traveling region calculating portion 36, the non-movement region calculating portion 37, the trajectory calculating portion 38, the boundary calculating portion 39, the trajectory detecting portion 40, and the operating portion 41 may be implemented by processing which the CPU 106 is made to perform by the program installed on the HDD 108.

The position acquiring portion 31 may include the input device 101. The position accumulating portion 32 may include a storage device which is coupled to, for example, the RAM 104, the HDD 108, or the gesture UI device 1 via a network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A gesture UI device comprising:
a CPU;
a memory configured to store a program which is executed by the CPU; and
a display device on which operation of screen is performed in accordance with a gesture input,
wherein the program causes the CPU to:
predict a direction of movement of a cursor on the screen on which a first object to be operated is displayed;
calculate a non-movement region to which the cursor is expected not to move based on the direction of movement of the cursor; and
place a second object to be operated on an inside of the non-movement region.

2. The gesture UI device according to claim 1, wherein the inside of the non-movement region includes a boundary of the non-movement region.

3. The gesture UI device according to claim 1, wherein
the CPU displays a graphic having an opening or a line that guides the direction of movement of the cursor on the screen as the second object to be operated.

4. The gesture UI device according to claim 1, wherein
the CPU calculates, based on a position of the cursor with respect to the first object to be operated, a non-operation region to which the cursor is expected not to move when the first object to be operated is operated, calculates a non-traveling region to which the cursor is expected not to travel based on a position and an orientation of the cursor, and calculates the non-movement region based on the non-operation region and the non-traveling region.

5. The gesture UI device according to claim 4, wherein
the CPU calculates the non-traveling region to which the cursor is expected not to travel based on at least one of the orientation of the cursor and a direction of gravitational force.

6. A gesture UI method comprising:
predicting a direction of movement of a cursor on a screen which is operated in accordance with gesture input, the screen on which a first object to be operated is displayed; and
calculating, by a computer, a non-movement region to which the cursor is expected not to move based on the direction of movement of the cursor; and
placing a second object to be operated other than the first object to be operated on an inside of the non-movement region.

7. The gesture UI method according to claim 6, wherein the inside of the non-movement region includes a boundary of the non-movement region.

8. The gesture UI method according to claim 6, further comprising:
displaying a graphic having an opening or a line that guides the direction of movement of the cursor as the second object to be operated.

9. The gesture UI method according to claim 6, further comprising:
calculating, based on a position of the cursor with respect to the first object to be operated, a non-operation region to which the cursor is expected not to move when the first object to be operated is operated;
calculating a non-traveling region to which the cursor is expected not to travel based on a position and an orientation of the cursor; and
calculating the non-movement region based on the non-operation region and the non-traveling region.

10. The gesture UI method according to claim 9, further comprising:
calculating the non-traveling region to which the cursor is expected not to travel based on at least one of an orientation of the cursor and a direction of gravitational force.

11. A computer-readable recording medium that records a program, the program causing a computer to:
predict a direction of movement of a cursor on a screen which is operated in accordance with gesture input, the screen on which a first object to be operated is displayed;
calculate a non-movement region to which the cursor is expected not to move based on the predicted direction of movement of the cursor; and
place a second object to be operated on an inside of the non-movement region.

12. The computer-readable recording medium according to claim 11, wherein the inside of the non-movement region includes a boundary of the non-movement region.

13. The computer-readable recording medium according to claim 11, wherein a graphic having an opening or a line that guides the direction of movement of the cursor is displayed as the second object to be operated.

14. The computer-readable recording medium according to claim 11, wherein
a non-operation region to which the cursor is expected not to move when the first object to be operated is operated is calculated based on a position of the cursor with respect to the first object to be operated,
a non-traveling region to which the cursor is expected not to travel is calculated based on a position and an orientation of the cursor, and
the non-movement region is calculated based on the non-operation region and the non-traveling region.

15. The computer-readable recording medium according to claim 14, wherein
the non-traveling region to which the cursor is expected not to travel is calculated based on any one of an orientation of the cursor and a direction of gravitational force.
